(19) United States
(12) Patent Application Publication
(10) Pub. No.: US 2013/0018771 A1
(43) Pub. Date: Jan. 17, 2013

(54) LOGGED DERIVATIVE CONTRACT

(71) Applicants: Richard Co, Chicago, IL (US); Steve Youngren, Elgin, IL (US); John Wiley, New York, NY (US); David Boberski, Westport, CT (US); John Labuszewski, Westmont, IL (US)

(72) Inventors: Richard Co, Chicago, IL (US); Steve Youngren, Elgin, IL (US); John Wiley, New York, NY (US); David Boberski, Westport, CT (US); John Labuszewski, Westmont, IL (US)

(21) Appl. No.: 13/183,186

(22) Filed: Jul. 14, 2011

(51) Int. Cl. G06Q 40/00

(52) U.S. Cl. 705/37

(57) ABSTRACT

The disclosed embodiments relate to creation and administration by automated means of Logged derivatives contracts. These contracts, e.g. a futures contract or “over the counter” (OTC) derivative, are cash-settled derivatives based on, and quoted by reference to, the natural logarithm of the value of the underlying product, e.g., the S&P 500.

### BACKGROUND

Futures Exchanges, referred to herein also as an “Exchange”, such as the Chicago Mercantile Exchange Inc. (CME), provide a marketplace where futures and options on futures are traded. Futures is a term used to designate all contracts covering the purchase and sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. Each futures contract is standardized and specifies commodity, quality, quantity, delivery date and settlement. Cash Settlement is a method of settling a futures contracts by cash rather than by physical delivery of the underlying asset whereby the parties settle by paying/receiving the loss/gain related to the contract in cash when the contract expires.

Typically, the Exchange provides a “clearing house” which is a division of the Exchange through which all trades made must be confirmed, matched and settled each day until offset or delivered. The clearing house is an adjunct to the Exchange responsible for settling trading accounts, clearing trades, collecting and maintaining performance bond funds, regulating delivery and reporting trading data. Essentially mitigating credit. Clearing is the procedure through which the Clearing House becomes buyer to each seller of a futures contract, and seller to each buyer, also referred to as a “novation,” and assumes responsibility for protecting buyers and sellers from financial loss by assuring performance on each contract. This is effected through the clearing process, whereby transactions are matched. A clearing member is a firm qualified to clear trades through the Clearing House. In the case of the CME's clearing house, all clearing members not specifically designated as Class B members are considered Class A clearing members. In the CME there are three categories of clearing members: 1) CME clearing members, qualified to clear transactions for all commodities; 2) IMM clearing members, qualified to clear trades for only IMM and IOM commodities; and 3) IMM Class B clearing members, solely limited to conducting proprietary arbitrage in foreign currencies between a single Exchange-approved bank and the IMM and who must be guaranteed by one or more Class A non-bank CME or IMM clearing member(s). Note that a “member” is a broker/trader registered with the Exchange.

As an intermediary, the Exchange bears a certain amount of risk in each transaction that takes place. To that end, risk management mechanisms protect the Exchange via the Clearing House. The Clearing House establishes clearing level performance bonds (margins) for all Exchange products and establishes minimum performance bond requirements for customers of Exchange products. A performance bond, also referred to as a margin, is the funds that must be deposited by a customer with his or her broker, by a broker with a clearing member or by a clearing member with the Clearing House, for the purpose of insuring the broker or Clearing House against loss on open futures or options contracts. This is not a part payment on a purchase. The performance bond helps to ensure the financial integrity of brokers, clearing members and the Exchange as a whole. The Performance Bond to Clearing House refers to the minimum dollar deposit which is required by the Clearing House from clearing members in accordance with their positions. Maintenance, or maintenance margin, refers to a sum, usually smaller than the initial performance bond, which must remain on deposit in the customer's account for any position at all times. The initial margin is the total amount of margin per contract required by the broker when a futures position is opened. A drop in funds below this level requires a deposit back to the initial margin levels, i.e. a performance bond call. If a customer's equity in any futures position drops to or under the maintenance level because of adverse price action, the broker must issue a performance bond/margin call to restore the customer's equity. A performance bond call, also referred to as a margin call, is a demand for additional funds to bring the customer's account back up to the initial performance bond level whenever adverse price movements cause the account to go below the maintenance.

As equity market volatility has fluctuated dramatically in recent years in response to an historic market decline and recovery in the wake of the so-called subprime mortgage crisis, sophisticated equity investors have increasingly sought specialized strategies and products to address the attendant risks. For example, traders may manage option positions by delta hedging, i.e. an options strategy that aims to reduce (hedge) the risk associated with price movements in the underlying asset by offsetting long and short positions. However, such traders are often frustrated by the need to manage actively the hedge as market volatility fluctuates. These traders may find it necessary frequently to manage or adjust the hedging transaction with the attendant implications of incurring transaction costs and possibly whipsaw markets.

Further, spread traders are often frustrated by the need to manage the “spread ratio” associated with an inter-market spread as spread ratios are dynamic due the difference in valuation of the of the futures contracts making up the legs of the spread as well as the general vagaries of the marketplace. A trader must constantly re-valuate the spread ratio in order to place the hedge in a rational manner. This further implies that one might re-adjust one's holdings to maintain the appropriate ratio as it fluctuates over time.

### BRIEF DESCRIPTION OF THE DRAWINGS

FIG. 1 shows a block diagram of an exemplary network for trading futures contracts, including in which payer contracts may be implemented, according to one embodiment.

FIG. 2 a block diagram of an exemplary implementation of the system of FIG. 1 for administering logged derivatives contracts.

FIG. 3 depicts a flow chart showing operation of the system of FIGS. 1 and 2.

FIG. 4 shows an illustrative embodiment of a general computer system 400 for use with the system of FIG. 1.

FIG. 5 shows a graph depicting the value of S&P 500 as compared to logged value of the S&P 500 over an exemplary time period.

FIG. 6 shows a graph depicting the logged value of the S&P 500 as compared to an exemplary range of index values thereof.

FIG. 7 shows a graph depicting the values of the S&P 500 and Nasdaq 100 over an exemplary time period.

FIG. 8 shows a graph depicting the value of E-mini S&P Futures as compared with E-mini Nasdaq Futures over an exemplary time period.

FIG. 9 shows a graph depicting the S&P: Nasdaq Spread Ratio over an exemplary time period.

FIG. 10 shows a graph depicting the logged spread ratio of the S&P:Nasdaq spread over an exemplary time period.

FIG. 11 shows a table of exemplary parameters of a contract according to the disclosed embodiments.

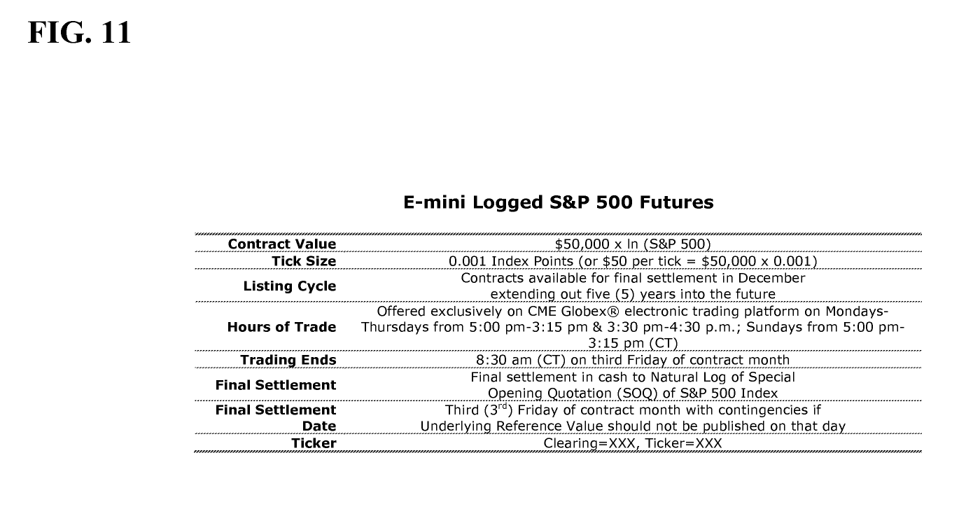

### DETAILED DESCRIPTION OF THE DRAWINGS AND PRESENTLY PREFERRED EMBODIMENTS

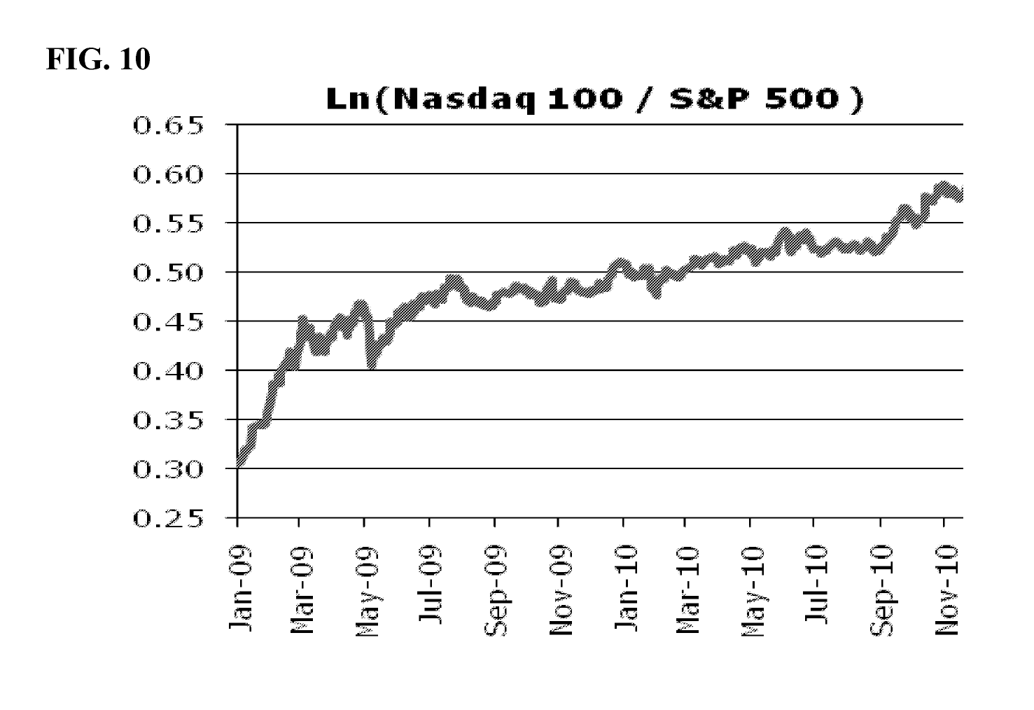

The disclosed embodiments relate to creation and administration Logged derivatives contracts, exemplary parameters of which are shown in FIG. 10. These contracts, e.g. a futures contract or “over the counter” (OTC) derivative, are cash-settled derivatives based on, and quoted by reference to, the natural logarithm of the value of the underlying product, e.g., the S&P 500. It will be appreciated that the disclosed embodiments may also be applicable to futures contracts for physically delivered underlying assets, in particular where offsetting of opposing positions negates the delivery obligation. The properties of a logged contract provide advantages including: (1) the ability to utilize an outright futures/forward position in a logged contract to replicate the convexity normally associated with an option; (2) facilitation of inter-market spreading between two logged contracts to the extent that the spread ratio may not change or require adjustment; and (3) facilitation of the quotation of inter-market spreads because of the unique mathematical properties of the natural logarithmic function. The disclosed embodiments may be applicable to all CME Group product areas including stock indexes, interest rates, currencies and commodities.

In particular, the difference between the natural logarithms of two values equates to the natural logarithm of the ratio of those two values. It is a group isomorphism, i.e. a one to one mapping where, if two objects are isomorphic, then any property that is preserved by an isomorphism and that is true of one of the objects, is also true of the other, e.g. ln(x)−ln(y)=ln(x/y). Consider a stock index that increases from 1000.00 points to 1010.00 points over a 1 week period, or exactly a 1% increase. The difference in the natural logarithmic levels will be:

ln(1010.00)−ln(1000.00)≈6.9177−6.9077=0.01=1%.

In fact, the difference the in natural logarithmic level of the index will be approximately equal to the percentage change, provided that the percentage change is a reasonably small number. As such, if a contract is written to have a fixed monetary multiplier of the index, e.g. $100,000 per logarithmic index point, the performance of the contract will be approximately the percentage change of the underlying index times the multiplier, regardless of the initial level of the index itself. E.g., if the initial index level is 1500.00, an increase of 1% in the index will leave the ending index level of 1515.00 In terms of the difference in logarithmic level:

ln(1515.00)−ln(1500.00)≈7.3232−7.132=0.01=1%.

Thus, the performance of the contract for the 1% move in the market is $1,000 regardless of where the starting index value is.

Conversely, a traditional index futures contract will have a fixed monetary multiplier of the index, e.g. $100 per index point. The 1% increase in the index under the two scenarios above will have different performance: $1000 in the former case and $1500 in the latter case. This is so because the traditional index futures will represent different amount of initial investment, $100,000 in the former case and $150,000 in the latter case. This amount is dependent on the initial level of the index.

As will be pointed out later, this independence from the initial value lends itself well to an application of the logarithmic futures very well: relative performance between different indexes.

As discussed above, equity market volatility has fluctuated dramatically in recent years in response as result of the so-called subprime mortgage crisis. Sophisticated equity investors have increasingly turned to specialized products to address the attendant risks. As such, a logged derivatives contract, referred to herein as logged contract or logged futures contract, etc. such as a logarithmic (“logged”) S&P 500 futures contract, as well as other similarly constructed contracts, including those for stock indices, interest rates, currencies and commodities, may be considered as a risk management vehicle offering various attractive features. For example, logged contracts provide unique value towards the construction of spread transactions because of the mathematical properties of the log transformation as explained below.

For example, Traders managing option positions by delta hedging, i.e. an options strategy that aims to reduce (hedge) the risk associated with price movements in the underlying asset by offsetting long and short positions, are often frustrated by the need to manage actively the hedge as market volatility fluctuates. These traders may find it necessary frequently to manage or adjust the hedging transaction with the attendant implications of incurring transaction costs and possibly whipsaw markets.

Further, spread traders are often frustrated by the need to manage the “spread ratio” associated with an inter-market spread. Further, it is often difficult to quote inter-market spreads in the context of ratio spreads.

As was discussed above, traditional index futures contracts have their performance tied to both the initial index value as well as the percentage change in the index value. Typically, inter-market spreads between two different futures contracts are placed to ensure that one holds equal and offsetting monetary exposures, e.g. long $10 million in S&P 500 exposure and short $10 million in NASDAQ-100 exposure. However, the spread ratio between the two futures contracts is dynamic, which requires actively managing an inter-market spread trade. That is, because the two futures contracts may be valued at very different monetary values, one must calculate the appropriate number of futures contracts to hold on both legs of the spread.

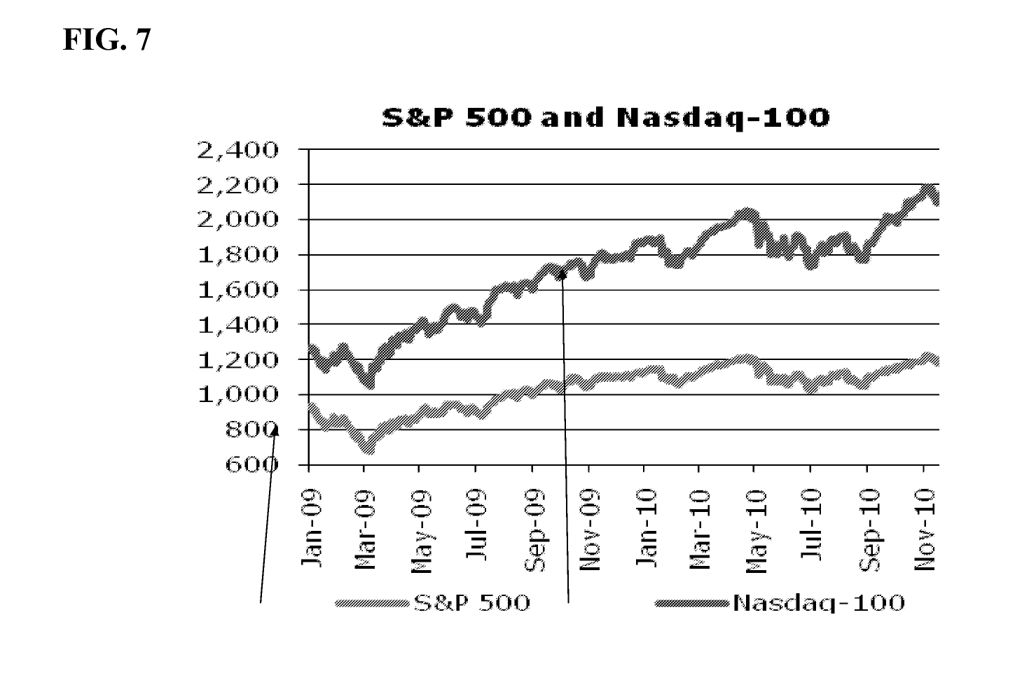

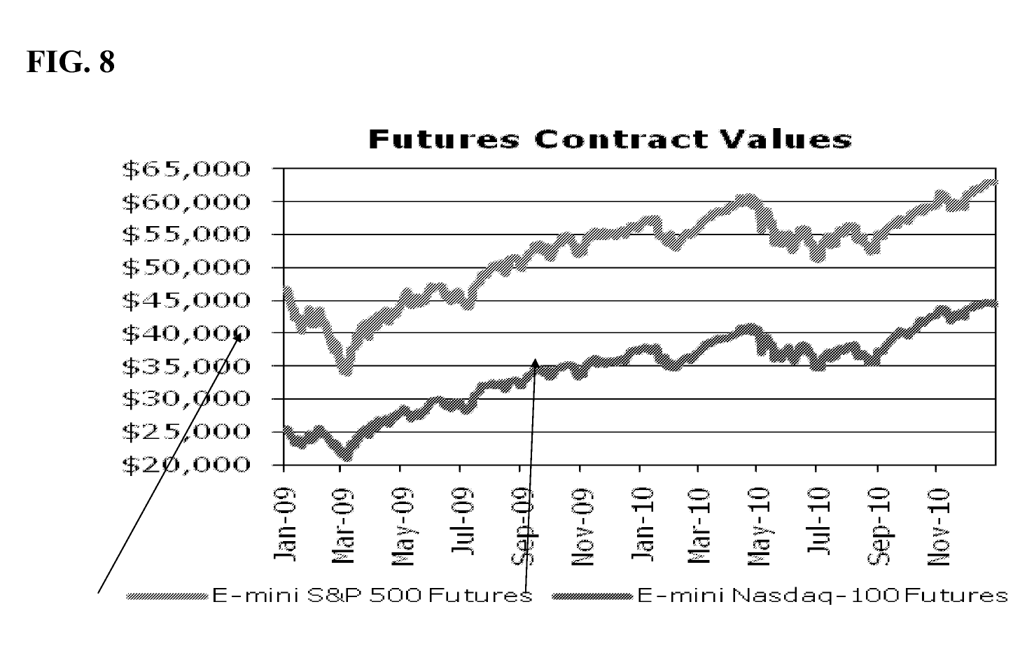

For example, as shown in FIG. 7, the Nasdaq-100 was at 2,217.86 index points with the S&P 500 at 1,257.64 index points on Dec. 31, 2010. As shown in FIG. 8, E-mini Nasdaq-100 futures are valued at $20×Index; while E-mini S&P 500 futures contract are valued at $50×Index. Thus, E-mini Nasdaq-100 futures might be valued near $44,357 (˜$20×2,217.86); while E-mini S&P 500 futures were near $62,882 (˜$50×1,257.64).

The appropriate “spread ratio” may be calculated as follows where Value1 and Value2 represent the monetary value (in a common currency as necessary) of the two futures contracts that are the subject of the spread.:

Spread Ratio=Value1÷Value2
E.g., the spread ratio between E-mini S&P 500 and E-mini Nasdaq-100 futures might be calculated as 1.4 using input values as discussed in the example above.
In other words, one might spread 10 E-mini S&P 500 futures vs. 14 E-mini Nasdaq-100 futures.

$$\begin{matrix}Spread Ratio := ValueS \& P 500 \div ValueNasdaq \\ = \$62 , 882 \div \$44 , 357 \\ = 1.4 \sim 10 S \& P : 14 Nasdaq futures\end{matrix}$$

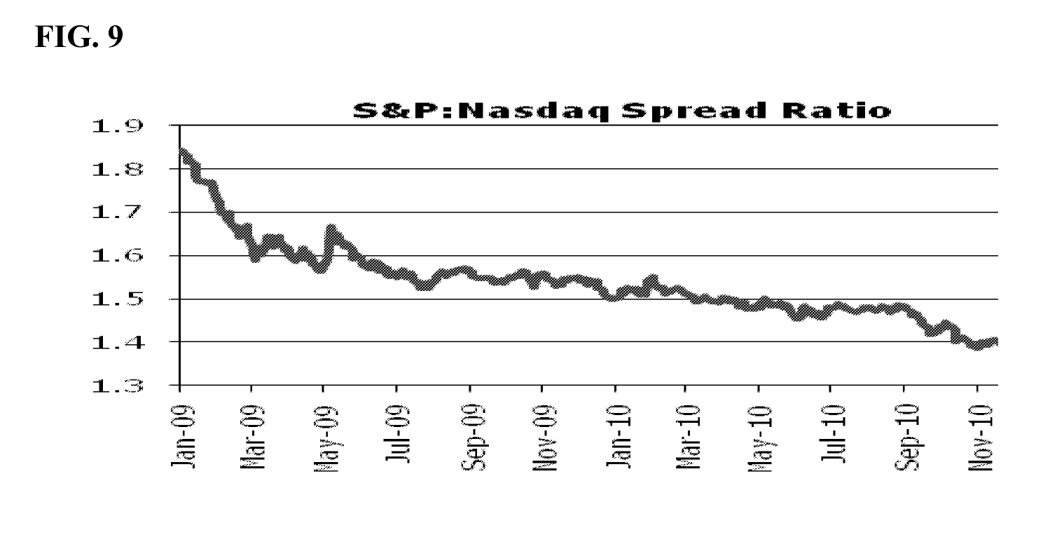

However, as shown in FIG. 9, this spread ratio is dynamic and constantly changes as a function of the vagaries of the marketplace. In recent years, the ratio has been as high as 1.8 and as low as 1.4. This implies that one must constantly re-valuate the spread ratio in order to place the hedge in a rational manner. This further implies that one might re-adjust one's holdings to maintain the appropriate ratio as it fluctuates over time.

Unlike the traditional index futures design, spreading the logarithmic versions of the index futures will feature fixed hedge ratios. If the monetary multipliers of the logarithmic index futures are identical, the hedge ratio would always be 1:1. Further, regardless of when the spread position is entered into, the performance of the spread will reflect precisely the percentage difference in the performance of the two indices, multiplied by the common monetary multiplier of the two logarithmic index futures.

Further, beyond the difficulties associated with placing the spread, there remains the basic problem of how one might quote a “ratioed” inter-market spread. While one may be inclined to simply quote the arithmetic difference between the two underlying values, the result will not adequately depict the pecuniary results of holding the spread on a ratioed basis. This is particularly true if an option based on the performance differential between two indexes were to be listed. Owing to the fluctuating hedge ratio, an option on the performance differential based on the traditional index futures becomes very impractical. There is no such inconvenience associated with the logarithmic index futures. Options can be written on the long/short spread at a 1:1 ratio of the logarithmic index futures. The strike prices can be easily defined. For example, if the current difference in the logarithmic index futures prices for the two indexes is 4.5689, a strike price of 4.5789 (=4.5689+0.0100) would represent the first index outperforming the second index by 1% between now and the expiration of the option. This becomes a very elegant solution for listing options on index spreads.

To be more specific, the options on the intercommodity spread of logged index futures would be constructed as such: The buyer of the options would have the right to exercise the option to buy (in case of a call option), or sell (in case of a put option), the long/short combination of the logged index futures for two distinct indexes. E.g. Long NASDAQ-100−Short S&P 500 spread. Should the option buyer exercise a call option with a strike price of 0.570, the option buyer will gain a long log-NASDAQ-100 futures/short log-S&P 500 futures spread at a price differential of 0.570. Thus, if the log-NASDAQ-100 futures is established at a price of 7.6962 (=log(2200)), the log-S&P futures position is established at a price of 7.6962−0.570=7.1262 (=log(1244)). Each of the logged index futures will then be treated as a free-standing position, capable of being offset against other logged index futures positions. Conversely, a put option in the same spread can be exercised into a combination of short log-NASDAQ-100/long log-S&P 500 futures positions. Using the same numerical example, if the strike price is 0.57, the log-futures thus established will carry the assigned prices of 7.6962 and 7.1262 respectively for the log-NASDAQ-100 and the log-S&P-500 index futures.

In creating the options in the aforementioned manner, we make use of the fact that:

ln(index1_Ending Value)−ln(index1_Beginning Value)=percentage change in index 1

ln(index2_Ending Value)−ln(index2_Beginning Value)=percentage change in index 2

[ln (index1_Ending Value)−ln(index1_Beginning Value)]−[ln(index2_Ending Value)−ln(index2_Beginning Value)]=difference in index performance

Further, by rearranging the formula,

[ln(index1_Ending Value)−ln(index1_Beginning Value)]−[ln(index2_Ending Value)−ln(index2_Beginning Value)]=

[ln(index1_Ending Value)−ln(index2_Ending Value)]−[ln(index1_Beginning Value)−ln(index2_Beginning Value)]

This latter representation, in fact, becomes the differential of the log-index futures value at the end vs. the differential of the log-index futures value at the beginning. Therefore, the option strikes can be set based to the log-futures price differential. This approach accomplishes the quest to have the option value reflecting the performance differential in the two indexes.

Generally, the disclosed embodiments relate to a contract for the delivery of the an underlying asset which is cash settled at a multiplier of the value of the underlying asset, for example, $50,000× the natural logarithm of the value of the S&P 500 [$50,000×ln(S&P 500)]. It will be appreciated that the selection of a particular multiplier is implementation dependent and that any appropriate multiplier may be used, including no multiplier, i.e. a multiplier of 1. As described above, the natural log essentially values the futures contract as the percentage price movement relative to the actual value of the underlying asset which, for example, is useful, as will be discussed, for comparing futures contracts for the purposes of creating, quoting and maintaining a spread.

For example, the natural log of 1,200.00 index points equals 7.0901 [=ln(1,200.00)]. This equates to a notional contract value of $354,503.84 (=$50,000×7.0901). If the index advances to 1,201.00, the natural log becomes 7.0909 [=ln(1,201.00)]. This equates to a notional contract value of $354,545.49 (=$50,000×7.0909).

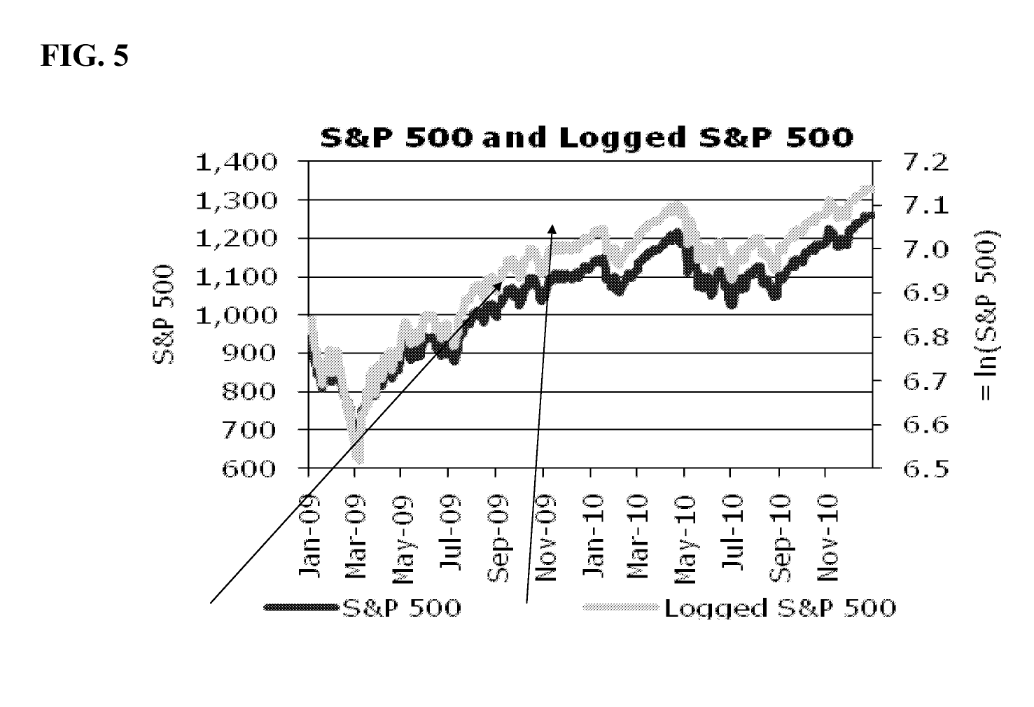

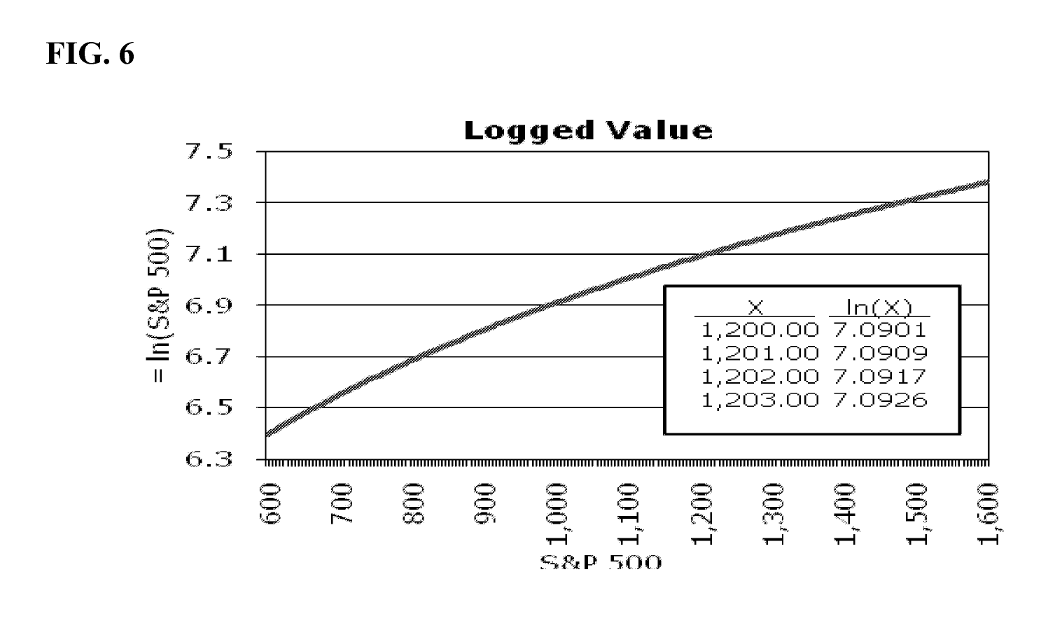

Referring to FIG. 5, as another example, with the S&P 500 at the level of 1,200, the contract implies an exposure to the S&P 500 at approximately $42 per index point. If the S&P 500 were at 1,000, contract exposure increases to approximately $50 per index point; and if the S&P 500 were to be at 1,400, contract exposure decreases to approximately $36 per index point. Accordingly, much like an option, a logged contract, due to the mathematical properties of the logarithmic function, offers non-zero convexity relative to the underlying index. Thus, a long position in a logged contract strongly resembles a short put; a short position resembles a long put. A logged contract, as shown in FIG. 6, conveys the convexity or gamma associated with an option without explicitly taking on time value decay or theta, i.e. the measure of the rate of decline in the value of an option due to the passage of time. Thus, equity portfolio managers might sell the contract and construct a hedge that resembles a long-term long put option without explicitly paying an option premium. It will be appreciated that the equivalent of the option of premium may be embedded in the costs associated with such a futures contract imparted by the market therefore.

As was discussed above, traders may manage option positions by delta hedging the delta and gamma exposures of a portfolio. Given that the logarithmic index futures inherently possess both delta and gamma (i.e. convexity), hedging certain exposures using the logarithmic index futures might be more efficient, in the sense that the frequency at which the portfolio manager trades in order to reduce the net delta exposure may be reduced. For example, an insurance company may issue an investment guarantee to its customer. Effectively, the investment guarantee behaves like a short put position the insurance company is engaged in vis-à-vis the customer. By shorting the logarithmic index futures, the inherent convexity of the payoff structure would help the insurance company reduce the re-hedging frequency for the de facto short put position vis-à-vis the customer. This reduction of the re-hedging need could potentially reduce the attendant transaction costs.

Further, as to why the portfolio manager might use options for the same purpose, it is noted that options inherently have “convexity” or gamma as well. The liquidity in the market for options decays quickly as the current market level strays farther away from the strike, or exercise, price of the option. The convexity in the option will also decay as the current market level strays farther away from the strike price. For longer term exposures like those undertaken by the exemplary insurance company in the form of investment guarantees, the loss in the liquidity and convexity (or gamma) in the options market is very unappealing. However, the logarithmic index futures will not suffer from the loss of convexity. Given that there is only one logarithmic index futures necessary for each expiration day, (unlike the multitude of options with different strikes with the same expiration), there will be less dilution in liquidity.

Logged contracts may be used as a proxy for options to the extent that they replicate the convexity or gamma, i.e. the rate of change for a ratio comparing the change in the price of the underlying asset to the corresponding change in the price of a derivative, sometimes referred to as the delta or “hedge ratio”, with respect to the underlying asset's price, associated with options. Note that many equity fund managers would like to purchase long-term put options as a hedge against “fat tail” risks. However, they are often discouraged by the high attendant option premiums. Logged futures or forwards do not require a premium payment but nonetheless may replicate option convexity.

While a log index futures contract is not the same as an option, a short position in a log futures contract resembles a long put options contract in the sense that as the index level drops, the gain from a put option and a short log index futures contract position accelerates, i.e. with each index point loss, the additional gain for the next index point decline increases. In the parlance of derivative markets, the instrument is said to have a positive gamma.

As was noted above, the advantage of a log index futures contract relative to put options is that as the market moves away from the strike price of an option, the market for that particular option will start to lose “liquidity”, i.e. less people will be inclined to trade that instrument and, as such, the price concession necessary to trade the option will be bigger and bigger, e.g. the value of the “optionality” starts to erode when the underlying index moves away from the strike price. Newer options trade will then be more prominent in around the then at-the-money strike. This is particularly true of longer-dated options.

In contrast, in the case of a log futures contract, there is no “strike”. There is only one contract per expiration. Accordingly, the gamma is preserved and thus there will be no loss of liquidity due to the market moving away from the strike as in the case of an option.

Thus, long-dated options and long-dated log futures are imperfect substitutes for one another, i.e. they are functional substitutes in the short run but the market dynamics of the two will not be the same in the long run.

Some traders managing option positions may resort to over-the-counter (OTC) variance contracts, i.e. an instrument which permits trading of variance risk, the risk that the squared volatility of the underlier returns changes randomly over time, to address these risks. OTC variance swaps are cash-settled to the variance (not standard deviation) of the underlying index. Variance swaps may be replicated by logged contracts of the disclosed embodiments. The logged contract has a further advantage that the contracts lack the explosive nature of a variance contract that might require prohibitive margin deposits.

Given the convex payoff structure, the logged contract may be expected to trade below the logarithm of the price of the S&P 500 futures with the same expiry. This “discount” reflects time to expiration as well as expected index volatility to expiration. Thus, the relative pricing of logged S&P 500 futures and standard S&P 500 futures would reflect the term structure of the index.

In the case of traders managing option positions by resorting to over-the-counter (OTC) variance contracts, i.e. an instrument which permits trading of variance risk, as was discussed above the risk that the squared volatility of the underlier returns changes randomly over time, to address these risks. Variance swaps may be replicated by logged contracts of the disclosed embodiments. The logged contract has a further advantage that the contracts lack the explosive nature of a variance contract that might require prohibitive margin deposits.

A variance contract is simply a contract on the realized variance of the time series of the index values over a period of time. Variance is a statistical term and, generally, it is the sum of squares of the daily changes of the index for a period of time. As will be appreciated, if the index goes +1, −1, +1, −1 in four straight days, the market would not have moved and the accumulation of the squared changes is just 4. If the index goes +10, −10, +10, −10, the index would not have moved in 4 days (i.e. the index ended up at the same place as the starting point) but the accumulation of the squared changes is 400. If the index goes +100, −100, +100, −100, the accumulation of the squared changes will be 40,000. Therefore, the moves in the variance contract can be quite explosive, e.g. a magnitude of a move is 100 fold but the variance explodes by a factor of 10,000.

Log index futures contracts do not have this feature. When the index returns to the same place, so does the log level of the index. One can argue that, as the market has a catastrophic drop, the log index futures contract can collapse faster than the index level itself. But the variance can explode without the market necessarily dropping catastrophically.

Further, as was discussed above, typically, inter-market spreads between two different futures contracts are placed to ensure that one holds equal and offsetting monetary exposures. However, the spread ratio between the two futures contracts is dynamic, which requires actively managing an inter-market spread trade. That is, because, as shown in FIG. 7, the two futures contracts may be valued at very different monetary values, one must calculate the appropriate number of futures contracts to hold on both legs of the spread to maintain the desired spread ratio.

Derivative contracts that are constructed using a logged convention as described above facilitate spread transactions absent the difficulties often associated with spreading conventionally constructed derivative contracts.

Logged contracts may be constructed in a wide array of products including stock indexes, interest rates, currencies and commodities. The ease with which one may quote and place a spread may be facilitated to the extent that such contracts use a common monetary multiplier.

For example, as shown in FIG. 10, the Nasdaq-100 is at 2,217.86 while the S&P 500 is at 1,257.64. The logged versions of the respective contracts may be quoted at 7.7284 and 7.1370 as described above. The spread between the two contracts may readily be quoted as the simple difference between those two values, i.e., 0.5914.

If both contracts are valued at $50,000×ln(Index), then one may simply place the spread in a 1-for-1 ratio, i.e., one logged Nasdaq-100 futures vs. one logged S&P 500 futures.

There will be no subsequent need to readjust the spread ratio because of the unique properties of the logged contract.

For example, an insurance company may sell its customer an investment product, say a variable annuity contract. Inside the contract is a series of performance guarantees. This is akin the insurance company selling a put to the investor. In turn, the insurance company will need to manufacture the hedge for the short put position so to speak. Generally speaking, the insurance company will need to buy positions with the positive gamma (as explained above) by buying a put, or in the case of log futures contracts, shorting a quantity of log index futures contracts. By doing so, as the market declines, the payoff of the hedging position will accelerate, offsetting the guarantee the insurance company had extended to the investor. Absent either the put or the log index futures contract position, the insurance company can also accomplish the hedge by progressively selling more and more regular index futures to accomplish the same thing, i.e. the increasing rate of loss per index point of the benchmark index. In fact, insurance company tends to sell short the market as they fall and buy back the short position as the market rises (because the hedge is no longer needed to the same extent). At least, this is the “proper” behavior of the variable annuity hedging unit.

However, the use of the log index futures mitigates the need to do this hedging because of the inherent gamma in the log index futures. The dynamic hedge adjustment does not vanish from the market altogether. It is just shifted from the insurance company to its counterparty in the log index futures contract trade.

As such, an exchange need not necessarily list the spread between logged contracts as a separate line item in an electronic trading system, e.g., on the CME Globex® system. Further, the listing exchanges need not prescribe the appropriate spread ratio provided that the two contracts utilize the same monetary multiplier. Or if the two contracts representing the two legs of the spread are established with divergent monetary multipliers, one need only identify the ratio between those multipliers for use as the spread ratio, which subsequently would not waver.

Not only may the disclosed embodiments be used in inter-market spreading but they also be applied to spreading between two indices. For example, a log S&P futures contract is based on the percentage change in S&P 500. If the multiplier is $100,000, the performance is based on the percentage move of that $100,000 investment in the S&P index. Likewise, if we have a multiplier of $100,000 on the Log Nasdaq 100 index, the performance of the log Nasdaq 100 futures contract is based on the percentage move of that $100,000 investment in the Nasdaq 100 index. Thus, to trade the difference in the performance of S&P vs. NASDAQ, all a trader needs is to buy or sell 1 log S&P futures contract and sell or buy 1 log Nasdaq futures contract. If the two indexes goes up or down by the same percentage, the trader will have the gains and losses offset. If one gains more in percentage term than the other, only then will the trader have a net gain or loss. This is the point of the spread trade—relative performance.

If one were to trade regular index futures, they will first have to look at the value of each contract. As of Jun. 6, 2011, E-mini S&P has a multiplier of $50 and trades at approximately 1285 index points. Thus, the value of the contract is $64,250. E-mini NASDAQ 100 has a multiplier of $20 and trades at approximately 2274 index points. Thus, the value of the contract is $45,480. To “spread” the two indexes, you will need to trade the E-mini S&P and E-mini NASDAQ 100 at an approximate ratio of 7:10. This ratio, as you can see, will change over time and will generally be only approximate.

With this changing index value and spread ratio, there is no easy way to construct options on the spread. Once the option on the spread is constructed on a particular day, the spread ratio will begin to drift. After a couple of weeks, it could happen that the spread ratio will no longer be relevant. It would also be the case that the option will have to reference a particular period, e.g. from March 19 to June 19, say, because of this constraint. As such, a month into the listing of the spread option, the option is no longer relevant—thus the option will guarantee to lose liquidity over time.

In contrast, a spread of the log index futures contracts of the component indices will maintain the spread relationship throughout. It is always one-to-one spread, and the price difference in the log futures of the two contract will stay the same even if the two indexes go up or down by the same percentage magnitude. Thus, options on the spread of log index futures provide a way to write options on the performance differential that would otherwise prove impracticable using regular index futures.

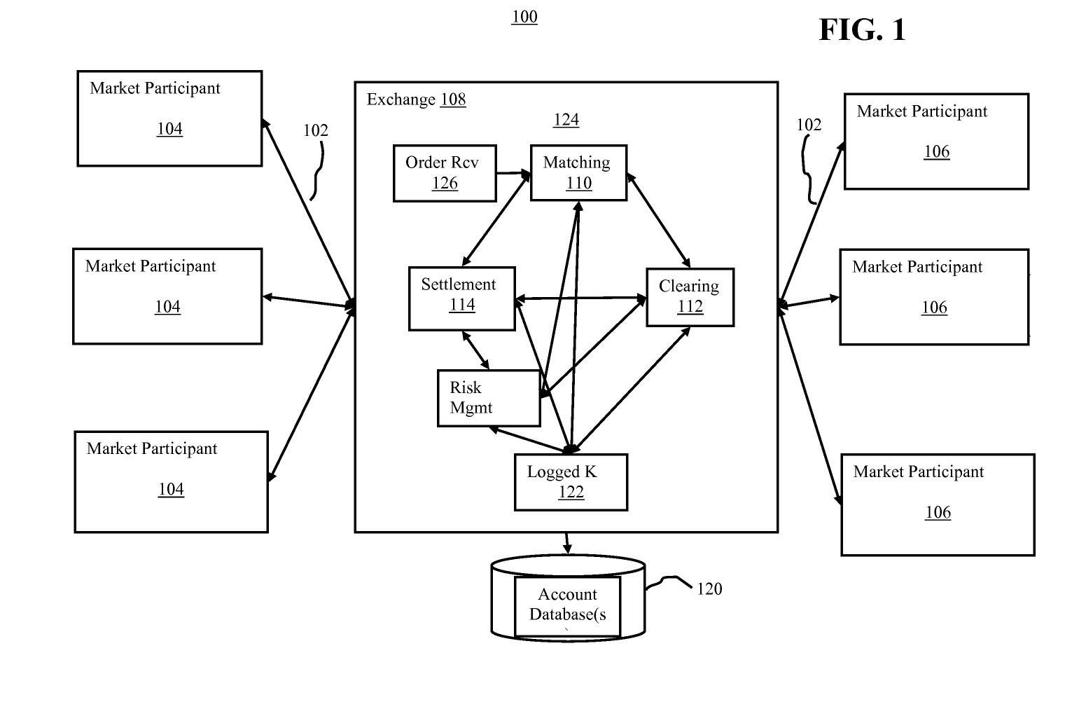

Referring now to FIG. 1, there is shown a block diagram of an exemplary network 100 for trading futures contracts, including in which payer contracts may be implemented, according to the disclosed embodiments. The network 100 couples market participants 104, 106, such as traders 104 and market makers 106, with an exchange 108, such as the CME, also referred to as a central counterparty or intermediary, via a communications network 102, such as the Internet, an intranet or other public or private, secured or unsecured communications network or combinations thereof. The network 100 may also be part of, or alternatively coupled with a larger trading network, allowing market participants 104 106 to trade products, such as futures contracts, options contracts, foreign exchange instruments, etc., via the exchange 108, including logged derivatives contracts as described herein. It will be appreciated that the plurality of entities utilizing the disclosed embodiments, e.g. the market participants 104, 106, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant 104 106 and/or the exchange 108.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

The exchange 108 implements the functions of matching 110 buy/sell transactions, clearing 112 those transactions, settling 114 those transactions and managing risk 116 among the market participants 104 106 and between the market participants and the exchange 108, as well as logged contract functionality 122 for administering logged contracts as will be described. The exchange 108 may include or be coupled with one or more database(s) 120 or other record keeping system which stores data related to open, i.e. un-matched, orders, matched orders which have not yet been delivered, or other data, or combinations thereof.

Typically, the exchange 108 provides a “clearing house” (not shown) which is a division of the Exchange 108 through which all trades made must be confirmed, matched and settled each day until offset or delivered. The clearing house is an adjunct to the Exchange 108 responsible for settling trading accounts, clearing trades, collecting and maintaining performance bond funds, regulating delivery and reporting trading data. Essentially mitigating credit. Clearing is the procedure through which the Clearing House becomes buyer to each seller of a futures contract, and seller to each buyer, also referred to as a “novation,” and assumes responsibility for protecting buyers and sellers from financial loss by assuring performance on each contract. This is effected through the clearing process, whereby transactions are matched. A clearing member is a firm qualified to clear trades through the Clearing House.

As used herein, the term “Exchange” 108 will refer to the centralized clearing and settlement mechanisms, risk management systems, etc., as described below, used for futures trading. In the presently disclosed embodiments, the Exchange 108 assumes an additional role as the central counterparty in logged derivatives contracts, computing logged values for the purposes of quoting, pricing and settling such contracts.

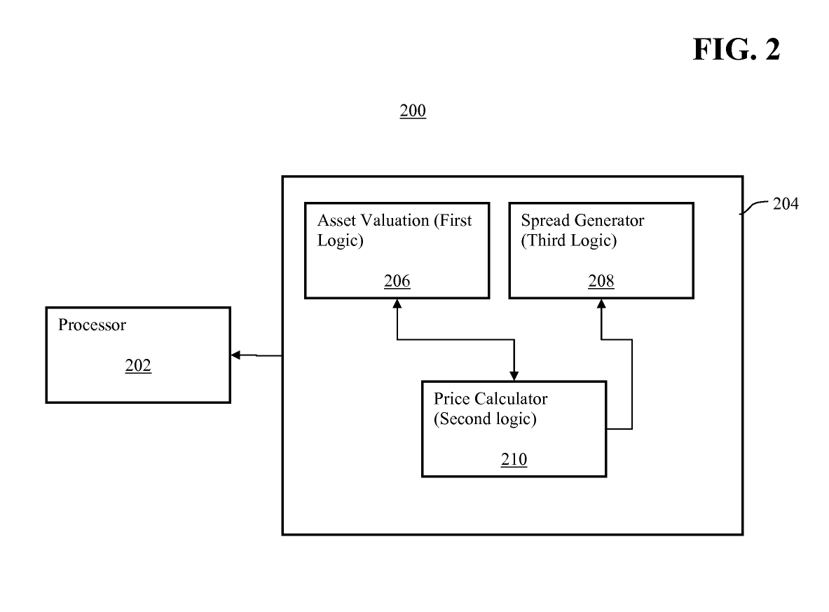

Referring to FIG. 2, a system 200 for computing a first price, e.g. a quote price and/or settlement price, of a first futures contract, such as a cash settled futures contract, for the delivery of a first underlying asset, such as a market index, according to one embodiment is shown. The system 200 implements logged contract functionality 122 of the system 100. The system 200, which may include a processor 202 and a memory 204 coupled therewith, includes an asset valuation processor 206, which may be implemented as first logic stored in the memory 204 and executable by the processor 202, coupled with the exchange 108 and/or network 102 so as to receive appropriate market information and operative to determine a value of the first underlying asset; and a price calculator 208, which may be implemented as second logic stored in the memory 204 and executable by the processor 202, coupled with the asset valuation processor 206 and operative to compute the first price based on a percentage price movement relative to the value of the first underlying asset, such as by computing the natural log of the value of the first underlying asset and, in one embodiment, further multiplied by a multiplier value. The price calculator 208 is further coupled with the exchange 108 and/or network 102 so as to provide the computed first price thereto.

It will be appreciated that the range of potential first prices of the first futures contract may be characterized by a convexity, similar to an options contract, with no decay over time, whereby an exchange may be operative to offer the first futures contract in place of an options contract.

The asset valuation processor 206 may be further operative to determine a value of a second underlying asset of a second futures contract, the price calculator 208 being further operative to compute a second price of the second futures contract for the delivery of the second underlying asset based on a percentage price movement relative to the value of the second underlying asset; and wherein the system 200 further includes a spread generator 210 coupled with the price calculator 208 and operative to generate a spread between the first and second futures contracts wherein the ratio of the first price to the second price does not change when the first and second underlying asset values undergo equivalent percentage changes relative to the value thereof.

As described above, the price calculator 208 is further operative to compute the percentage price movement relative to the value of the first underlying asset as the natural log of the value of the first underlying asset and compute the percentage price movement relative to the value of the second underlying asset as the natural log of the value of the second underlying asset. The first underlying asset may include an index derived from a first market and the second underlying asset comprises an index derived from a second market different from the first market. Alternatively, or in addition thereto, the first underlying asset may include a first index derived from a market and the second underlying asset comprises a second index derived from a market, the second index being different from the first index. The price calculator 208 may further generate a quote for the spread between the first and second contracts as the difference between the percentage price movements of each.

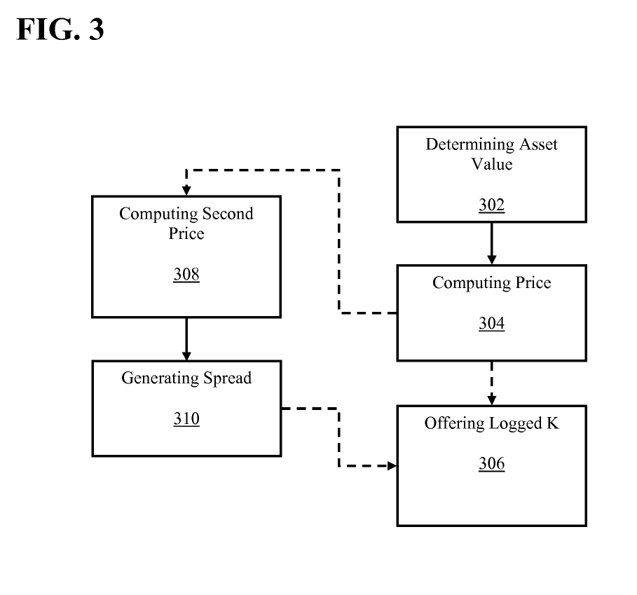

FIG. 3 depicts a flow chart showing operation of the system of FIGS. 1 and 2. In particular FIG. 3 shows a computer implemented method of computing a first price, such as a quoted price or settlement price, of a first futures contract for the delivery of a first underlying asset, such as a cash settled futures contract. The method includes determining, by a processor, such as the processor 202 described above, a value of the first underlying asset (block 302) and computing, by the processor, the first price based on a percentage price movement relative to the value of the first underlying asset (block 304), such as by computing the natural log of the value of the first underlying asset. It will be appreciated that the range of potential first prices of the first futures contract are characterized by a convexity with no decay over time. The method may further include offering, by an exchange couple with the processor, the first futures contract in place of an options contract (block 306). The first price may be further computed based on a multiplier multiplied by the natural log of the value of the first underlying asset.

The method may further include: computing, by the processor, a second price of second futures contract for the delivery of a second underlying asset based on a percentage price movement relative to the value of the second underlying asset (block 308); and generating, by the processor, a spread between the first and second futures contracts wherein the ratio of the first price to the second price does not change when the first and second underlying asset values undergo equivalent percentage changes relative to the value thereof (block 310). The percentage price movement relative to the value of the first underlying asset may be computed, as described above, as the natural log of the value of the first underlying asset and the percentage price movement relative to the value of the second underlying asset may be computed as the natural log of the value of the second underlying asset. In one embodiment, the first underlying asset comprises an index derived from a first market and the second underlying asset comprises an index derived from a second market different from the first market. Alternatively, or in addition thereto, the first underlying asset comprises a first index derived from a market and the second underlying asset comprises a second index derived from a market, the second index being different from the first index.

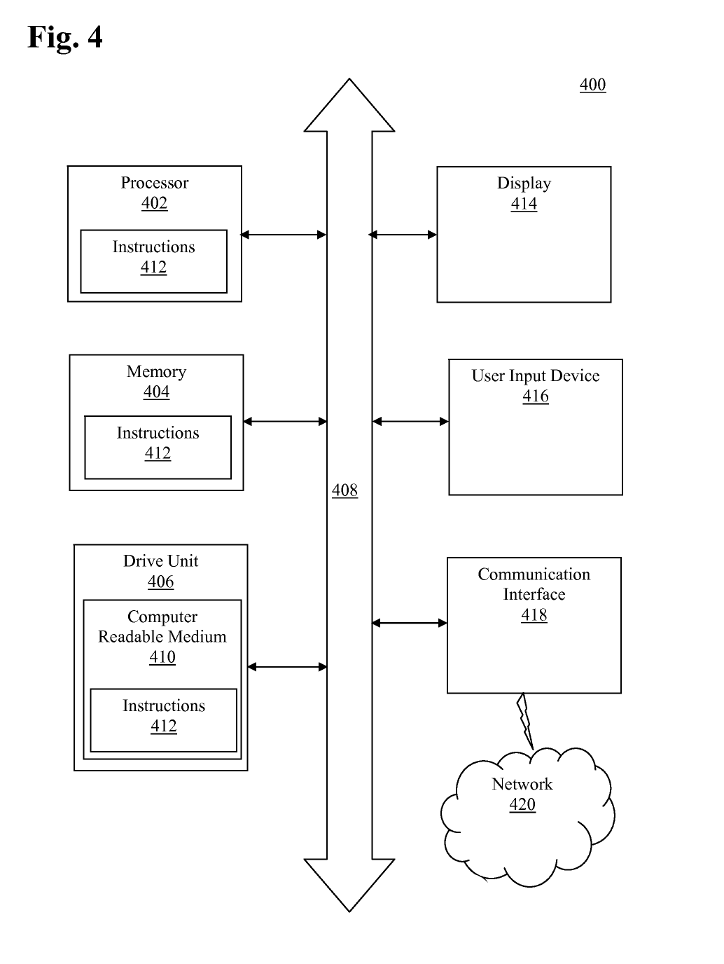

Referring to FIG. 4, an illustrative embodiment of a general computer system 400 is shown. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, margin processing, payment or clearing function on behalf of an exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

We claim:

1. A computer implemented method of computing a first price of a first futures contract for the delivery of a first underlying asset, the method comprising:
determining, by a processor, a value of the first underlying asset; and
computing, by the processor, the first price based on a percentage price movement relative to the value of the first underlying asset.

2. The computer implemented method of claim 1 wherein the first futures contract comprises a cash settled futures contract.

3. The computer implemented method of claim 1 wherein the first price comprises one of a quoted price or a settlement price.

4. The computer implemented method of claim 1 further comprising computing, by the processor, the percentage price movement relative to the value of the first underlying asset as the natural log of the value of the first underlying asset.

5. The computer implemented method of claim 1 wherein a range of potential first prices of the first futures contract are characterized by a convexity with no decay over time.

6. The computer implemented method of claim 1 further comprising offering, by an exchange coupled with the processor, the first futures contract in place of an options contract.

7. The computer implemented method of claim 1 wherein the first price is further computed based on a multiplier multiplied by the natural log of the value of the first underlying asset.

8. The computer implemented method of claim 1 further comprising computing, by the processor, a second price of second futures contract for the delivery of a second underlying asset based on a percentage price movement relative to the value of the second underlying asset; and
generating, by the processor, a spread between the first and second futures contracts wherein the ratio of the first price to the second price does not change when the first and second underlying asset values undergo equivalent percentage changes relative to the value thereof.

9. The computer implemented method of claim 8 further comprising computing, by the processor, the percentage price movement relative to the value of the first underlying asset as the natural log of the value of the first underlying asset and computing, by the processor, the percentage price movement relative to the value of the second underlying asset as the natural log of the value of the second underlying asset.

10. The computer implemented method of claim 8 wherein the first underlying asset comprises an index derived from a first market and the second underlying asset comprises an index derived from a second market different from the first market.

11. The computer implemented method of claim 8 wherein the first underlying asset comprises a first index derived from a market and the second underlying asset comprises a second index derived from a market, the second index being different from the first index.

12. A system for computing a first price of a first futures contract for the delivery of a first underlying asset, the system comprising:
an asset valuation processor operative to determine a value of the first underlying asset; and
a price calculator coupled with the asset valuation processor and operative to compute the first price based on a percentage price movement relative to the value of the first underlying asset.

13. The system of claim 12 wherein the first futures contract comprises a cash settled futures contract.

14. The system of claim 12 wherein the first price comprises one of a quoted price or a settlement price.

15. The system of claim 12 wherein the price calculator is further operative to compute the percentage price movement relative to the value of the first underlying asset as the natural log of the value of the first underlying asset.

16. The system of claim 12 wherein a range of potential first prices of the first futures contract are characterized by a convexity with no decay over time.

17. The system of claim 12 further being coupled with an exchange operative to offer the first futures contract in place of an options contract.

18. The system of claim 12 wherein the price calculator is further operative to compute the first price based on a multiplier multiplied by the natural log of the value of the first underlying asset.

19. The system of claim 12 wherein the asset valuation processor is further operative to determine a value of a second underlying asset of a second futures contract, the price calculator being further operative to compute a second price of the second futures contract for the delivery of the second underlying asset based on a percentage price movement relative to the value of the second underlying asset; and
wherein the system further comprises:
a spread generator coupled with the price calculator and operative to generate a spread between the first and second futures contracts wherein the ratio of the first price to the second price does not change when the first and second underlying asset values undergo equivalent percentage changes relative to the value thereof.

20. The system of claim 19 wherein the price calculator is further operative to compute the percentage price movement relative to the value of the first underlying asset as the natural log of the value of the first underlying asset and compute the percentage price movement relative to the value of the second underlying asset as the natural log of the value of the second underlying asset.

21. The system of claim 19 wherein the first underlying asset comprises an index derived from a first market and the second underlying asset comprises an index derived from a second market different from the first market.

22. The system of claim 19 wherein the first underlying asset comprises a first index derived from a market and the second underlying asset comprises a second index derived from a market, the second index being different from the first index.

23. A system for computing a first price of a first futures contract for the delivery of a first underlying asset, the system comprising a processor and a memory coupled therewith, the system further comprising:
first logic stored in the memory and executable by the processor to determine a value of the first underlying asset; and
second logic coupled with the first logic and stored in the memory and executable by the processor to compute the first price based on a percentage price movement relative to the value of the first underlying asset.

24. A system for computing a first price of a first futures contract for the delivery of a first underlying asset, the system comprising:
means for determining a value of the first underlying asset; and
means for computing the first price based on a percentage price movement relative to the value of the first underlying asset.
